(19) United States
(12) Patent Application Publication
(10) Pub. No.: US 2018/0374114 A1
(43) Pub. Date: Dec. 27, 2018

(54) Advertising with Shoe Shine Incentive

(71) Applicant: Sami Movsesian, Glendale, CA (US)

(72) Inventor: Sami Movsesian, Glendale, CA (US)

(21) Appl. No.: 15/634,908

(22) Filed: Jun. 27, 2017

(51) Int. Cl. G06Q 30/02

(52) U.S. Cl. CPC G06Q 30/0234; G06Q 50/10; G06Q 30/0283; G06Q 30/0242

(57) ABSTRACT

An advertising system offering shoe shining services to members of the public in exchange for receiving advertising content and providing inputs to the system indicative of paying attention to the advertising content. The apparatus includes an automatic shoe shine machine and a communications system such as an interactive display screen. When a member of the public uses the automatic shoe shine machine, advertising content is displayed on the display screen or transmitted audibly or both. The shoe shine service is fulfilled responsive to one or more interactive inputs by the member of the public.

### FIELD OF THE DISCLOSURE

The present disclosure relates to services offered promotionally, and more particularly, to offering shoe shine services as a promotional incentive in support of advertising.

### BACKGROUND

Advertising venues are heavily saturated with advertising content, and are so numerous and ubiquitous as to be frequently ignored by potential customers of goods and services. There exists a need for new and enticing advertising venues.

### SUMMARY

The disclosed concepts address the above stated situation by providing an advertising apparatus providing a useful and desirable service as an enticement to view advertising content. Namely, an automatic shoe shining machine may be combined with a viewing screen to combine providing a shoe shining service with advertising content displayed on the viewing screen.

The service may be provided for free. To assure that potential customers actually view the advertising content, the advertising apparatus may require interactive inputs by the potential customer enjoying the shoe shine service. For example, questions may be displayed on the viewing screen, with the potential customer entering manual inputs to answer the questions. It may be inferred from the answers that the potential customer is actually viewing advertising content.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a diagrammatic view of apparatus used to implement a method of advertising, according to at least one aspect of the disclosure;

FIG. 2 is a diagrammatic perspective view of the apparatus of FIG. 1;

FIG. 3 illustrates exemplary display screen content which may be displayed on the apparatus of FIG. 1; and

FIG. 4 illustrates other exemplary display screen content which may be displayed on the apparatus of FIG. 1.

### DETAILED DESCRIPTION

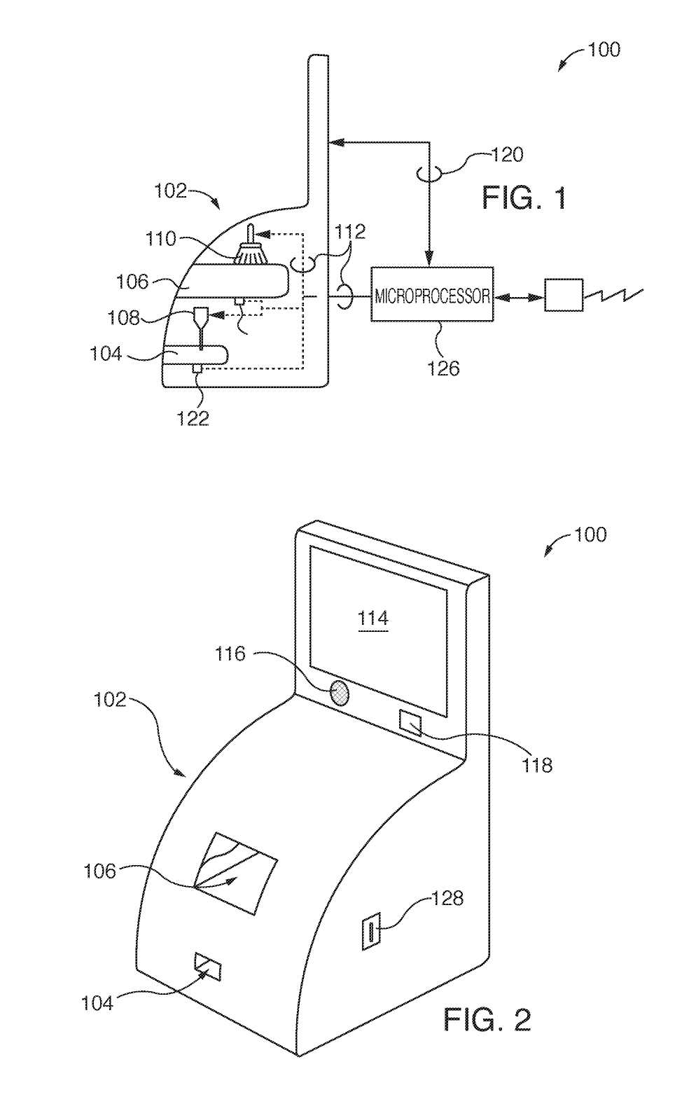

Referring first to FIGS. 1 and 2, there is shown apparatus 100 to be used in a method of advertising according to at least one aspect of the disclosure. Apparatus 100 includes an automatic shoe shining apparatus 102 including a first receptacle 104 for receiving a shoe (not shown) worn by a user of system 100 and a second receptacle 106. In first receptacle 104, a shoe shining substance such as wax is dispensed onto the shoe by a dispenser 108. Once the shoe shining substance has been dispensed, the user removes the shoe, which may be worn on the foot, and inserts the shoe into second receptacle 106. Second receptacle 106 includes apparatus (shown representatively as a rotary brush 110) to spread and buff the shoe shining substance. Dispenser 108 and rotary brush 110 are shown only in abbreviated or representative form in FIGS. 1 and 2, and will be understood to include all apparatus necessary for operation, such as additional rotary brushes (not shown), motors (not shown), and control and power circuitry 112. If not inhibited from operation, rotary brush 110 will spread the shoe shining substance over most of the shoe, and will fully buff areas of the shoe intended to bear the shoe shining substance. As will be further explained hereinafter, full buffing is accomplished only when the user interactively engages system 100.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

Automatic shoe shining apparatus comprises a communications system including a display screen 114, and optionally, a speaker 116 and a microphone 118, and communications support circuitry 120. It will be understood that although not shown in full detail, communications support circuitry 120 will include all necessary conductors, connections, and other components for operability of the communications system as described herein.

Automatic shoe shining apparatus 102 may include a first sensor 122 operable to sense insertion into first receptacle 104 of the shoe of a person using apparatus 100. Automatic shoe shining apparatus 102 may include a second sensor 124 operable to sense insertion into second receptacle 106 of the shoe of the person using apparatus 100. First and second sensors 122, 124 are in communication with a microprocessor 126 controlling apparatus 100. Microprocessor 126 and other control and power components may be housed within automatic shoe shining apparatus 102, or alternatively, may be remote therefrom.

Sensing of insertion of a shoe into first receptacle 104 may initiate operation of system 100. Alternatively, a value receptor 128, which may be for example a coin receiver and processor, a receiver and processor of paper currency, or a credit or debit card reader, may initiate operation of system 100.

Automatic shoe shining apparatus 102 may include, for example, elements of a 3D Polisher Media Station, a product of Medskland Company Limited, 25/1, Musi Djalilya Street, Novosibirsk, Russian Federation.

A method of advertising, according to at least one aspect of the disclosure, and utilizing system 100, may include making available to members of the public (not shown) an automatic shoe shining apparatus 102; providing advertising content discernible to a member of the public at automatic shoe shining apparatus 102; and providing an automatic shoe shining service to the member of the public responsive to an interactive input to the automatic shoe shining apparatus 102, where the interactive input is indicative of the member of the public paying attention to the advertising content.

Advertising will be considered discernible when displayed on display screen 114, or alternatively or in addition to visual display on display screen 114, when audibly issuing from speaker 116. Interactive inputs include physical inputs to display screen 114, which may be a touchscreen, operation of a mouse (not shown), keypad (not shown) or a keyboard (not shown), where the keypad or keyboard are optionally made part of system 110, or spoken responses received by microphone 118. Of course, other known interface devices (none shown) may be substituted for or used in addition to the specific examples of input and output devices listed herein. An output device will be understood to encompass display screen 114, speaker 116, and any other device which issues discernible advertising, prompts, and instructions. An input device will be understood to encompass display screen 114 (if a touchscreen), microphone 118, the mouse, the keypad, the keyboard, or other user interface device adapted to receive signals by manipulation by the user.

In the method of advertising, the user interface may be a text based interface, such as the keypad or the keyboard. Alternatively, the user interface may comprise a graphic user interface displayed on display screen 114.

Display screen 114 may comprise a touch responsive surface, wherein the interaction requires the member of the public to touch display screen 114 to conduct the novel method of advertising.

The method of advertising may further comprise providing speaker 116 connected to automatic shoe shining apparatus 102 and microphone 118 connected to automatic shoe shining apparatus 102, wherein the communications system may issue audible prompts and may respond to audible interactive inputs.

In the method of advertising, making available to members of the public the automatic shoe shining apparatus 102 may comprise providing an automatic shoe shining apparatus 102 including dispenser 108 of the shoe shine substance and application apparatus (represented as rotary brush 110), wherein the application apparatus spreads and buffs the shoe shine substance.

In the method of advertising, providing the communications system may further comprise providing display screen 114 capable of displaying imagery to a person utilizing automatic shoe shining apparatus 102, and displaying advertising content on display screen 114.

The method of advertising may further comprise providing a communications system which provides the advertising content discernible to the member of the public, wherein the communications system transmits the interactive inputs by the member of the public to control the automatic shoe shining apparatus 102. The communications system will be understood to encompass input and output features, such as display screen 114, speaker 116, and microphone 118, as well as unillustrated alternatives to display screen 114, speaker 116, and microphone 118, such as for example the keypad, the keyboard, and the mouse, circuitry 112 and 120, and microprocessor 126.

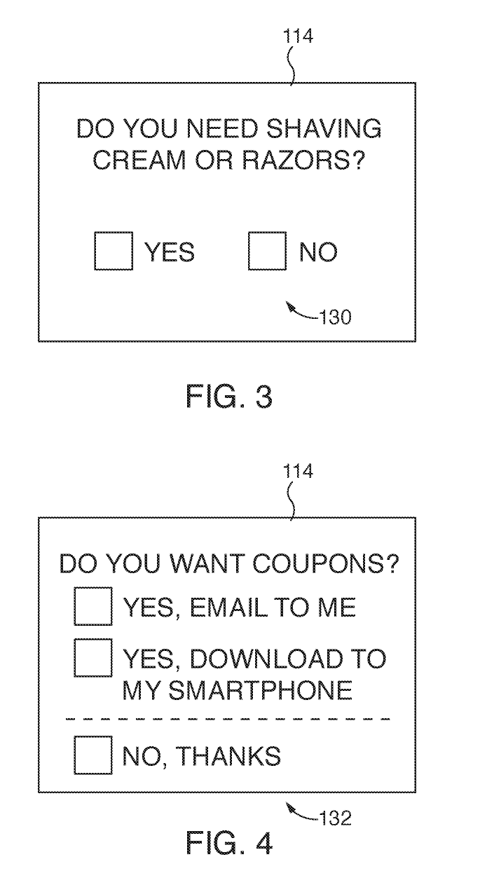

In an important feature of the method of advertising, operation of automatic shoe shining apparatus is dependent upon interactive inputs by the user to assure that advertising content is actually being observed and received by the user of system 100. Turning now to FIG. 3, there is shown an example of a prompt which may be part of the advertising content. In the example illustrated in FIG. 3, the prompt is in the form of indicia 130 posing a query as to whether the user is in need of a particular good (shaving cream and razors). Should the user touch the displayed box next to indicia 130 representing an affirmative response (“yes”), or should the user touch the displayed box next to indicia 130 representing a negative response (“no”) within a predetermined time interval after first displaying indicia 130, microprocessor 126 will continue the shoe shining service by enabling dispenser 108 or the spreading and buffing apparatus represented by rotary brush 110 to continue in operation. If an appropriate response is not received with the predetermined time interval, microprocessor 126 will inhibit further operation.

System 100 may pose more than one query or other action to effect the interactive input by the user. As shown in FIG. 4, second indicia 132 requiring an interactive input may be displayed. Once again, failure to obtain an appropriate response within the predetermined time interval (which may of different duration than a prior predetermined time interval) may inhibit further operation.

In summary, the method of advertising may further comprise issuing at least one visual prompt on display screen 114; providing a user interface associated with display screen 114 enabling interaction between automatic shoe shining apparatus 102 and the member of the public poised to receive the automatic shoe shining service; and enabling fulfillment of the automatic shoe shining service responsive to interaction by the member of the public with the user interface. As stated before, the interface may be display screen 114 itself, or alternatively, microphone 118, the keyboard, the keypad, the mouse, or still another interface device.

System 100 may have a communications facility 134, for example, wireless connection to the internet, or to telephone services. As suggested in FIG. 4, system 100 may be configured to transmit a virtual coupon by email or message to a smailphone (not shown).

In a further optional feature, the method of advertising may comprise offering the member of the public a discount responsive to the interaction by the member of the public. When the member of the public accepts an offer for a discount, the method may further comprises delivering a virtual coupon to the member of the public. Delivering the virtual coupon to the member of the public may comprise downloading the virtual coupon to a mobile communications device (e.g., a smailphone, not shown) operated by the member of the public.

The discount may take forms other than the virtual coupon without generating either a real or virtual discount. For example, delivering the virtual coupon to the member of the public may comprise downloading an authorization for a discount to a provider of goods and/or services selected by the member of the public.

The method of advertising may utilize other ways to ultimately provide a free service such as the shoe shining service. The method of advertising may further comprise establishing an initial fee to use automatic shoe shining apparatus 102; and refunding at least a portion of the initial fee to the member of the public responsive to the interactive input by the member of the public. Refunding at least a portion of the initial fee may further comprise refunding a first portion of the initial fee to the member of the public responsive to a first interactive input by the member of the public; and refunding at least a second portion of the initial fee to the member of the public responsive respectively to at least a subsequent interactive input by the member of the public. The entire initial fee may be refunded in steps, so that the service ultimately becomes free. Where more than one step of refunding is practiced, or even where there is no initial fee, providing the automatic shoe shining service to a member of the public responsive to the interactive input to automatic shoe shining apparatus 102 may further comprise providing plural prompts (e.g., as illustrated in FIGS. 3 and 4), each inviting one interactive input by the member of the public, and making completion of the automatic shoe shining service dependent upon receiving a qualified interactive input for each of the plural prompts.

In this application, characteristics are recited with the understanding that prevailing conditions are those of ordinary use of the described subject matter. Therefore, although characteristics could change given circumstances other than the ordinary intended usage of the novel apparatus or method, such changes are to be ignored.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

I claim:

1. A method of advertising, comprising:
making available to members of the public an automatic shoe shining apparatus;
providing advertising content discernible to a member of the public at the automatic shoe shining apparatus; and
providing an automatic shoe shining service to the member of the public responsive to an interactive input to the automatic shoe shining apparatus, where the interactive input is indicative of the member of the public paying attention to the advertising content.

2. The method of claim 1, wherein making available to members of the public the automatic shoe shining apparatus comprises providing an automatic shoe shining apparatus including a dispenser of a shoe shine substance and application apparatus, wherein the application apparatus spreads and buffs the shoe shine substance.

3. The method of claim 1, further comprising providing a communications system which provides the advertising content discernible to the member of the public, wherein the communications system transmits the interactive inputs by the member of the public to control the automatic shoe shining apparatus.

4. The method of claim 3, wherein providing the communications system further comprises providing a display screen capable of displaying imagery to a person utilizing the automatic shoe shining apparatus, and displaying advertising content on the display screen.

5. The method of claim 4, further comprising:
issuing at least one visual prompt on the display screen;
providing a user interface associated with the display screen enabling interaction between the automatic shoe shining apparatus and the member of the public poised to receive the automatic shoe shining service; and
enabling fulfillment of the automatic shoe shining service responsive to interaction by the member of the public with the user interface.

6. The method of claim 5, wherein the user interface is a text based interface. (eg, keypad)

7. The method of claim 5, wherein the user interface comprises a graphic user interface.

8. The method of claim 7, wherein the display screen comprises a touch responsive surface, and the interaction requires the member of the public to touch the display screen.

9. The method of claim 1, further comprising offering the member of the public a discount responsive to the interaction by the member of the public.

10. The method of claim 9, wherein, when the member of the public accepts an offer for a discount, the method further comprises delivering a virtual coupon to the member of the public.

11. The method of claim 10, wherein delivering the virtual coupon to the member of the public comprises downloading the virtual coupon to a mobile communications device operated by the member of the public.

12. The method of claim 10, wherein delivering the virtual coupon to the member of the public comprises downloading an authorization for a discount to a provider of goods and/or services selected by the member of the public.

13. The method of claim 1, further comprising:
establishing an initial fee to use the automatic shoe shining apparatus; and
refunding at least a portion of the initial fee to the member of the public responsive to the interactive input by the member of the public.

14. The method of claim 13, wherein refunding at least a portion of the initial fee further comprises:
refunding a first portion of the initial fee to the member of the public responsive to a first interactive input by the member of the public; and
refunding at least a second portion of the initial fee to the member of the public responsive respectively to at least a subsequent interactive input by the member of the public.

15. The method of claim 1, wherein providing an automatic shoe shining service to a member of the public responsive to the interactive input to the automatic shoe shining apparatus further comprises providing plural prompts each inviting one said interactive input by the member of the public, and making completion of the automatic shoe shining service dependent upon receiving a qualified interactive input for each of the plural prompts.

16. The method of claim 1, further comprising providing a speaker connected to the automatic shoe shining apparatus and a microphone connected to the automatic shoe shining apparatus, wherein the communications system may issue audible prompts and may respond to audible interactive inputs.
